(19) United States
(12) Patent Application Publication
(10) Pub. No.: US 2025/0322738 A1
(43) Pub. Date: Oct. 16, 2025

(54) DETECTION OF VIOLATIONS AND POTENTIAL ACTIONS FOR AERIAL DEVICES

(71) Applicant: QUALCOMM Incorporated, San Diego, CA (US)

(72) Inventors: Umesh PHUYAL, San Diego, CA (US); Stefano FACCIN, San Ysidro, CA (US); Chiranjib SAHA, Lakeside, CA (US); Sitaramanjaneyulu KANAMARLAPUDI, San Diego, CA (US); Le LIU, San Jose, CA (US); Alberto RICO ALVARINO, San Diego, CA (US)

(21) Appl. No.: 19/093,654

(22) Filed: Mar. 28, 2025

Related U.S. Application Data
(60) Provisional application No. 63/634,375, filed on Apr. 15, 2024.

(51) Int. Cl. G08B 21/18; H04W 4/021

(52) U.S. Cl. CPC G08B 21/18; H04W 4/021

(57) ABSTRACT

Aspects of the present disclosure relate to wireless communications, and more particularly, to techniques for managing violations by aerial devices, such as unmanned aerial vehicles (UAVs). One aspect provides a method for violation detection. The method includes detecting, at a first network entity, a violation of an area restriction by an aerial device; and triggering a notification to a second network entity based on the violation of the area restriction, the notification causing a warning notification to be sent regarding the violation of the area restriction.

### CROSS-REFERENCE TO RELATED APPLICATION

This application claims benefit of and priority to U.S. Provisional Application No. 63/634,375 filed Apr. 15, 2024, which is hereby expressly incorporated by reference herein in its entirety as if fully set forth below and for all applicable purposes.

### BACKGROUND

### Field of the Disclosure

Aspects of the present disclosure relate to wireless communications, and more particularly, to techniques for managing violations by aerial devices, such as unmanned aerial vehicles (UAVs).

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for violation detection. The method includes detecting, at a first network entity, a violation of an area restriction by an aerial device; and triggering a network exposure function (NEF) notification to a second network entity based on the violation of the area restriction, the NEF notification causing a warning notification to be sent regarding the violation of the area restriction.

Another aspect provides a method for violation detection by a first aerial device. The method includes performing aerial device monitoring to detect a violation of an area restriction; detecting the violation of the area restriction by a second aerial device based on the aerial device monitoring, the second aerial device being different than the first aerial device; and transmitting information regarding the aerial device to a cellular operator or a third party controller based on detecting the violation.

Another aspect provides a method for violation enforcement. The method includes detecting that an aerial device is violating an area restriction, wherein the area restriction is associated with one of multiple types of area restrictions; and taking an enforcement action in response to the area restriction being violated, wherein the enforcement action to be taken is identified based on the one of the multiple types of the area restriction.

Another aspect provides an apparatus for violation detection. The apparatus generally includes memory and one or more processors coupled to the memory and configured to: detect, at a first network entity, a violation of an area restriction by an aerial device; and trigger a notification to a second network entity based on the violation of the area restriction, the notification causing a warning notification to be sent regarding the violation of the area restriction.

Another aspect provides an apparatus for violation detection by a first aerial device. The apparatus generally includes memory and one or more processors coupled to the memory and configured to: perform aerial device monitoring to detect a violation of an area restriction; detect the violation of the area restriction by a second aerial device based on the aerial device monitoring, the second aerial device being different than the first aerial device; and transmit information regarding the aerial device to a cellular operator or a third party controller based on detecting the violation.

Another aspect provides an apparatus for violation enforcement, comprising memory and one or more processors coupled to the memory and configured to: detect that an aerial device is violating an area restriction, wherein the area restriction is associated with one of multiple types of area restrictions; and take an enforcement action in response to the area restriction being violated, wherein the enforcement action to be taken is identified based on the one of the multiple types of the area restriction.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example of an unmanned aerial vehicle (UAV).

FIG. 6 depicts an example deployment of UAVs, in accordance with aspects of the present disclosure.

FIG. 7 depicts an example architecture for network assisted support of UAVs.

FIG. 8 depicts an example architecture for network assisted support of UAVs, in accordance with aspects of the present disclosure.

FIGS. 9A and 9B illustrate example area restrictions.

FIG. 10 is a timing diagram illustrating example operations for managing aerial device special area restriction violations, in accordance with certain aspects of the present disclosure.

FIG. 11 illustrates stealth networks used to detect aerial device violations, in accordance with certain aspects of the present disclosure.

FIG. 12 depicts a method for violation detection by a radio access network (RAN).

FIG. 13 depicts a method for violation detection by an aerial device.

FIG. 14 depicts a method for violation enforcement.

FIGS. 15-17 depict aspects of example communications devices.

### DETAILED DESCRIPTION

Aspects of the present disclosure provide apparatuses, methods, processing systems, and computer-readable mediums for area restriction detection and enforcement for aerial devices, such as unmanned aerial vehicles (UAVs), also referred to as uncrewed aerial vehicles or drone. A UAV generally refers to an aircraft without any humans on board. UAVs may be deployed as part of an unmanned aircraft system (UAS) that may include a ground-based UAV controller (UAVC). At least some portions of the flight of a UAV may operate under remote control by a human operator, with autopilot assistance, or as a fully autonomous aircraft. UAVs may fly at a relatively low level when compared to conventional commercial aircraft (e.g., 5000 feet or lower). UAVs may also fly in different sets of scenarios than commercial aircraft, such as in crowded spaces (e.g., with 10 or more UAVs in a 1 square km area).

Certain aspects of the present disclosure are directed toward violation detection techniques. In some aspects, a radio access network (RAN) may detect a violation of an area restriction, such as a no-fly zone (NFZ) restriction, a no-transmit zone (NTZ) restriction, or a no-leave zone (NLZ) restriction. These types of restrictions are described in more detail herein. The RAN may perform aerial device monitoring to detect a violation without a third-party controller (e.g., UAS traffic management (UTM)) having solicited monitoring. The monitoring may be performed in an aerial device identifier agnostic manner (e.g., the RAN may monitor for any aerial device within an area instead of a specific aerial device based on a subscription for monitoring that aerial device). Once a violation is detected, the RAN may trigger a network exposure function (NEF) notification to an access management function (AMF) by providing information about the violation. The AMF may trigger an application function (AF) to send a warning notification regarding the violation, as described in more detail herein.

In some aspects, the detection of the violation may be based on an uplink (UL) path-loss of the aerial device. For example, the RAN may perform UL channel estimation to identify whether an aerial device is transmitting in an NTZ, or based on the path loss, determine whether the aerial device is within a NFZ or outsize an NLZ.

In some aspects, detecting the violation may involve detecting whether an aerial device has deviated from a flight path by a threshold distance, as described in more detail herein. In some implementations, one or more coordinated or trusted aerial devices may be deployed to monitor other aerial devices to detect violations. For instance, a trusted aerial device may fly around an NFZ to detect other aerial devices that may be violating the NFZ, or sensing for transmissions to identify whether other aerial devices are violating an NTZ.

In some implementations, a stealth network (e.g., a base station dedicated to violation detection) may be deployed to monitor aerial devices. The stealth network may coordinate with a serving network of an aerial device to identify the aerial device potentially violating a restriction for enforcement actions. Some aspects are directed towards implementing enforcement actions based on the detected violation type. For example, suppose the violation is a violation of a NTZ or NLZ restriction. In that case, the RAN may take action to prevent uplink (UL) signaling from the aerial device while maintaining network connectivity for the aerial device. For instance, UL resources may be not be configured for the aerial device. In this manner, downlink (DL) control signaling to the aerial device is still possible, which may involve command and control (C2) signaling to direct the aerial device outside the NTZ or NLZ. In some cases, the RAN may take action to transition the aerial device to idle or inactive mode based on the type of restriction being an NTZ or NLZ restriction.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

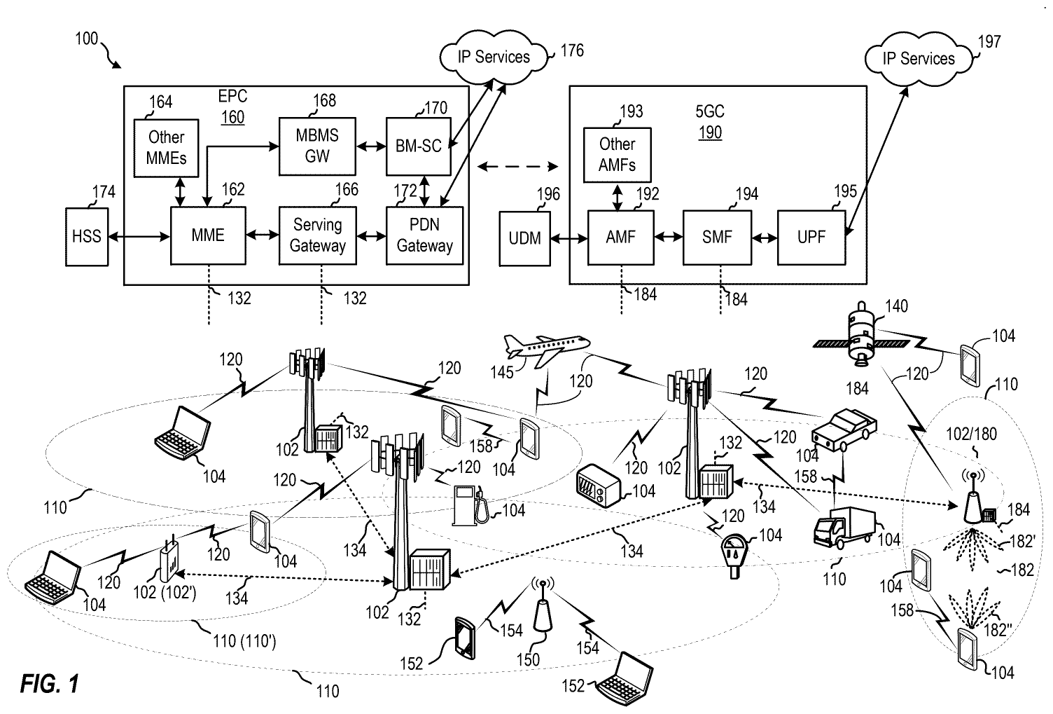

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

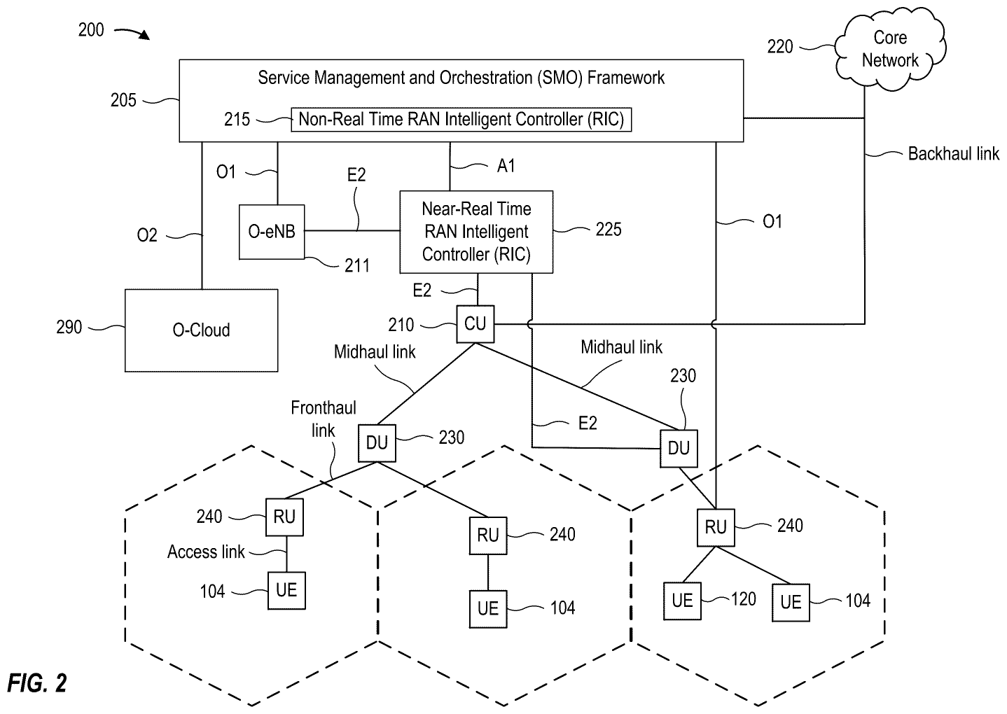

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHZ, which is sometimes referred to (interchangeably) as a “millimeter wave” (“mmW” or “mm Wave”). A base station configured to communicate using mm Wave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the El interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an Al interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

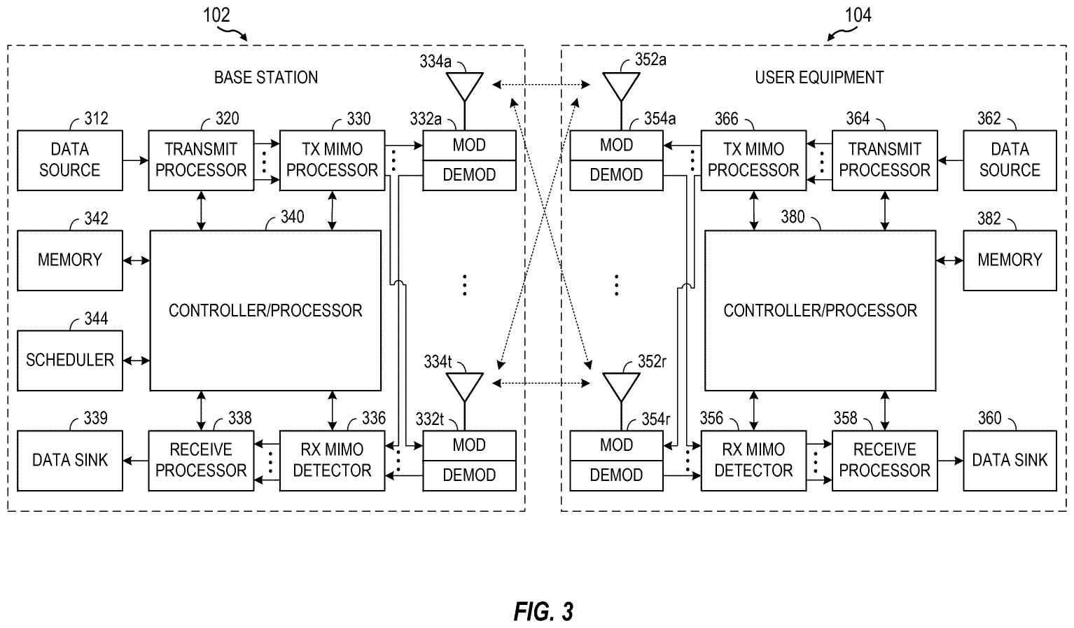

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

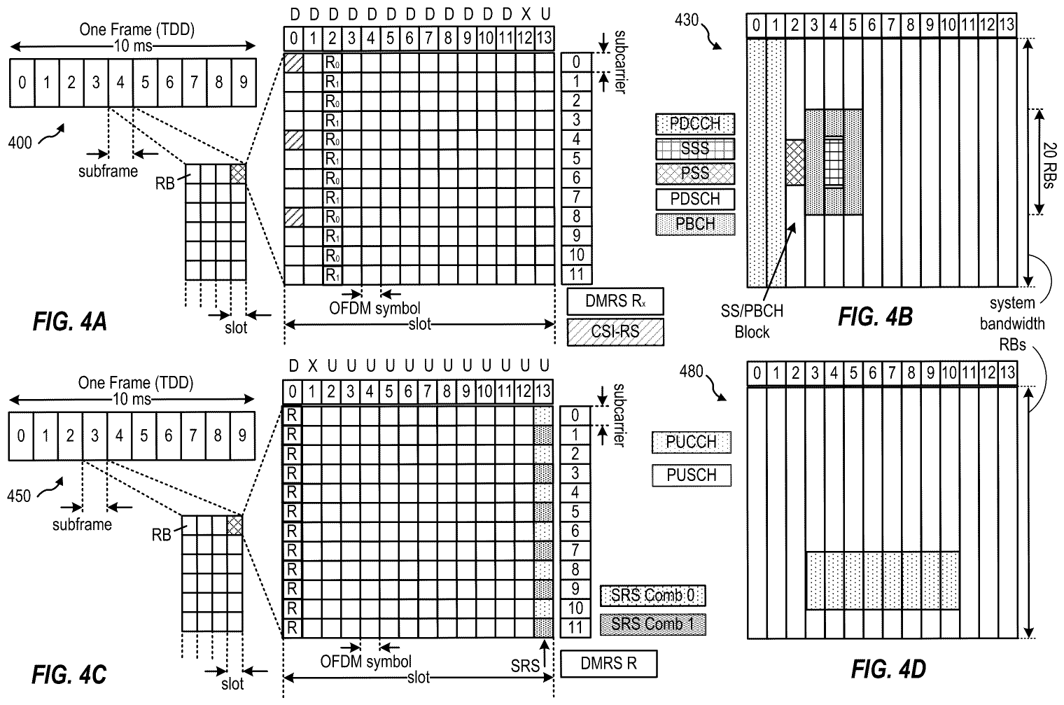

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIG. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 24×15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### An Overview of UAVs

As noted above, an unmanned aerial vehicle (UAV) generally refers to an aircraft (without any humans on board) that may be deployed as part of an unmanned aircraft system (UAS). UAVs may be deployed in different scenarios with different objectives for uplink transmission power control.

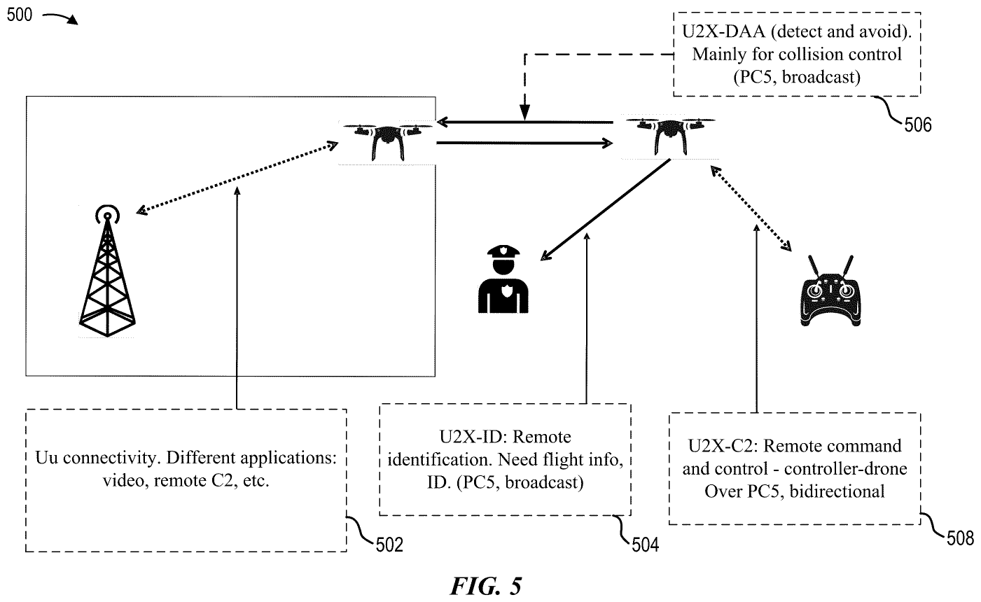

For example, as illustrated at 502 in the scenario 500 depicted in FIG. 5, on the cellular (Uu) link, a UAV may support different applications, such as video and remote command and control (C2) applications. As shown at 504, a UAV to everything (U2X) application may need identification, for example, with flight information (e.g., via a sidelink/PC5 broadcast). As shown at 506, a U2X detect and avoid (DAA) application identification may be used mainly for collision control (e.g., via PC5 broadcast). As shown at 508, a U2X-C2 remote command and control (a controller-drone) could reach up to 10 km, with communications over PC5 and possibly bidirectional.

Aspects of the present disclosure provide mechanisms that enable network-based aviation services for UAVs. As noted above, UAVs may be deployed as part of a UAS that typically includes a ground-based UAV controller (UAVC).

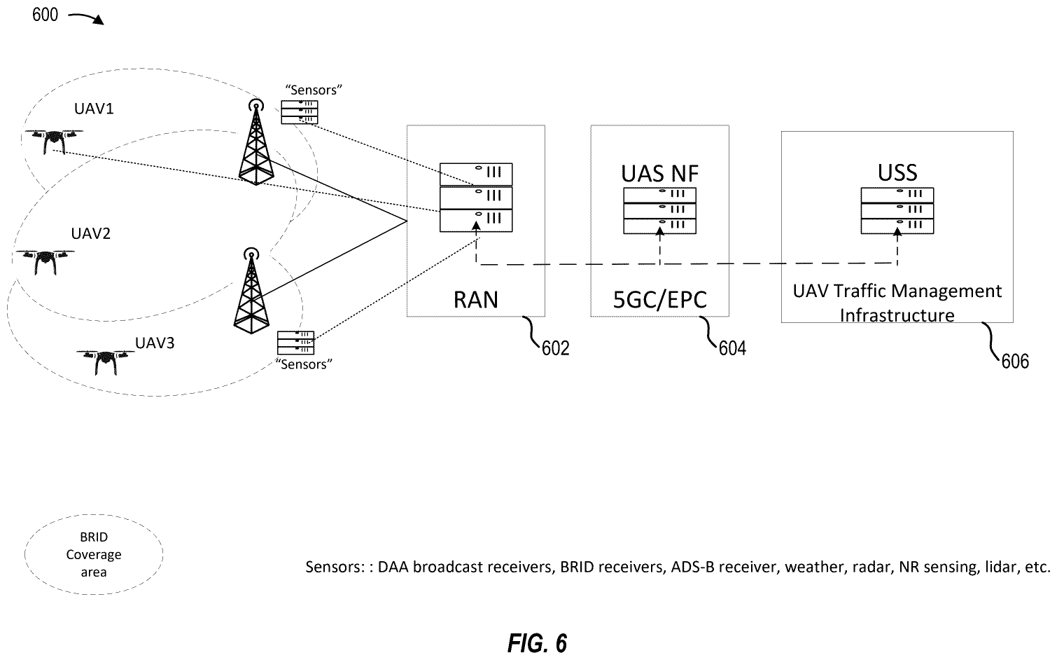

As illustrated in the example scenario 600 of FIG. 6, a radio access network (RAN) 602 may serve as a localized USS and/or UAS Traffic Management (UTM) node RAN nodes may enhance spatial awareness of UAVs within a UAS 604, based on information collected on UAVs (and other aerial vehicles). The network-assisted service proposed herein may rely on gNBs and other sources of information feeding data to the aerial service. In some cases, sensors may be deployed at gNBs (e.g., DAA broadcast receivers, BRID receivers, ADS-B receiver, weather, radar, NR sensing, LIDAR, etc.). Aerial service nodes may implement traffic separation algorithms and collision notification features across one or more cells. A UAV may be visible to multiple aerial services.

In some cases, certain aerial services/service providers could interact with and leverage various 5G core network functions, such as a network function (NF) to leverage a network exposure function (NEF) for interaction with global UTM and USSs 606. In some cases, an aerial service may provide (via NEF exposure), an aerial congestion information application programming interface (API) and UAV information to the USS, which may help to support the USS in flight authorization.

In some cases, a UAV may first need to discover whether a network provides network-based aviation service support (e.g., existence of an aerial service). In addition, or as an alternative, the network may need to learn whether the UE is capable of participating in network-based aviation service support (e.g., can communicate with an aerial service).

To accomplish this discovery, the UE (deployed on a UAV) may transmit signaling indicating the UE is associated with an unmanned aerial vehicle (UAV). This signaling may indicate that the UE is capable of supporting aerial service (or network assisted DAA, NA-DAA). The indication may be provided via non access stratum (NAS) signaling, such as 5G mobility management (5GMM) capabilities signaling. In some cases, the UE/UAV may receive signaling indicating that a network supports a network-based aviation service. For example, the network may provide an indication of aerial service.

In some cases, when registering in a public land mobile network (PLMN) registration procedure, the PLMN may indicate that aerial service is supported in a UE registration procedure. In some cases, aerial service availability may be indicated per PLMN. In other cases, aerial service availability may be indicated per Registration Area (RA). In some cases, an access and mobility management function (AMF) may also generate an RA in a manner designed to ensure that aerial services uniformly available in RA.

Aerial service may not be available in all locations within a wireless network. Therefore, in some cases, a cell system information block (SIB) may include an indication of “aerial available” when the aerial services available. A similar such indication may be sent via RRC establishment signaling. In either case, a gNB may be configured to know whether aerial services available.

As described herein, the network-assisted DAA (NADAA) solution proposed herein may leverage existing infrastructure and the support of UAVs via wireless networks. Aspects of the present disclosure also provide a mechanism to enable the core network to configure the RAN with information about the UAV and policies related to the NADAA service supported by a Localized DAA Service (aerial service).

In some cases, the aerial service may be provided by RAN and communication between a UAV and the aerial service may occur over a form of (modified) RRC signaling. In some cases, the aerial service may be provided by an edge server and communications carried out over user plane (UP) signaling between the UAV and the edge.

In some cases, an AMF may retrieve information from a unified data manager (UDM), may receive an explicit indication from the UAV, and policies from a Policy Control Function (PCF), related to the aerial service, and configure the RAN accordingly.

In some cases, if the aerial service is authorized, for example, via a (UAS) service suppliers (USS) UAV authorization/authentication (UUAA) procedure and UUAA session management (UUAA-SM) is used (at PDU session establishment), then the SMF may provide the configuration information to the RAN.

As noted above, AMF to RAN communications may be used to support the NADAA proposed herein. In some cases, upon UE registration, the UE may indicate a subscription. If the UE subscription is for an aerial UE (a UAV UE deployed on a UE) and if the AMF successfully authenticates the UAV UE, the AMF may authenticate and authorizes the UAV. In this case, the AMF may indicate to the RAN whether aerial service is authorized for this UE. In some cases, the AMF may also require successful UUAA authentication/authorization. In some cases, the UAV may also be expected to indicate (e.g., in 5GMM capabilities) that it supports aerial service.

For scenarios in which UUAA-SM is performed, the SMF may indicate to the RAN (e.g., by adding a new indication in N2 SM message) whether aerial service is authorized for the UE after UUAA-SM completion.

As noted above, in some cases, new network exposure function (NEF) services may be defined to support UAVs with network-assisted aerial services. For example, new NEF services may be introduced to enable an aerial service to register itself with the UAS NF (e.g., NEF) and with the USS, in order to retrieve information about a UAV that the aerial service is serving, and to receive configuration information from the USS.

As noted above, a UE that is capable of aerial service may indicate it supports aerial service at the application layer, for example, during a UUAA procedure to the USS. After the UAV indicates its aerial service capability to the USS, upon a successful UUAA procedure, the USS may provide the UAS NF an indication that NADAA is authorized.

In some cases, the aerial service may also interact with the USS to report detected UAS conflicts (e.g., potential UAV collisions) and corrective action to USS. In some cases, an interface may be defined between the aerial service to NEF/UAS NF to trigger signaling to the USS. In such cases, it may be assumed that the aerial service is not aware of the serving USS. In other words, no information about the serving USS may be provided to the aerial service and the aerial service may not discover the serving USS. Thus, even though the USS is not aware of the aerial service serving a UAV, the aerial service can communicate with the UAS NF, which communicates with USS.

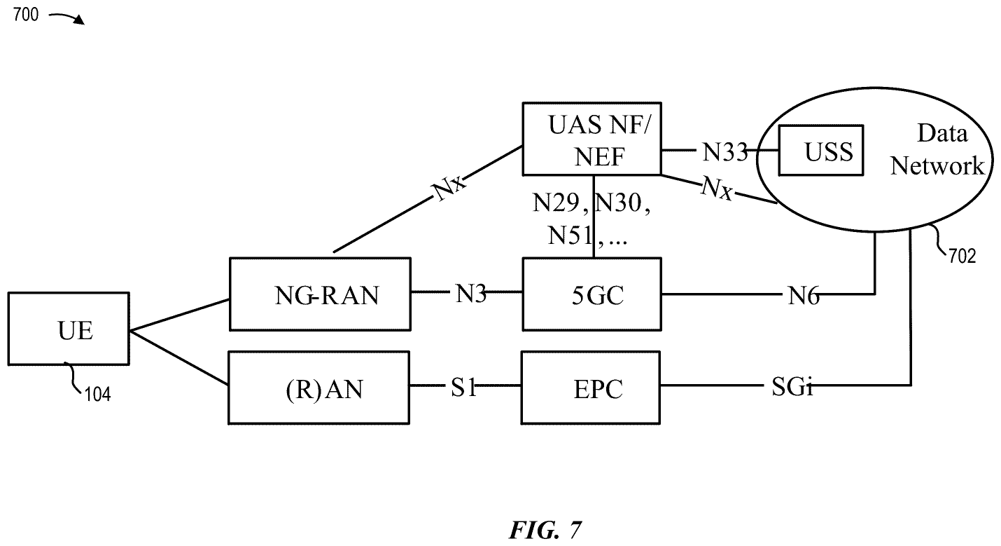

FIG. 7 illustrates an example architecture 700 of a network capable of providing network assisted aerial services to a UE 104 (e.g., a UE on a UAV). As illustrated, the aerial service may be located in a RAN (e.g., NG-RAN) or in a data network 702 (e.g., with the USS). As noted above, the aerial service may interact with the USS, via a UAS NF or NEF. In some cases, the aerial service may retrieve UAV information (e.g., public information, such as UAV category, mission type, etc.) from the USS via NEF as soon as the aerial service detects a UAV.

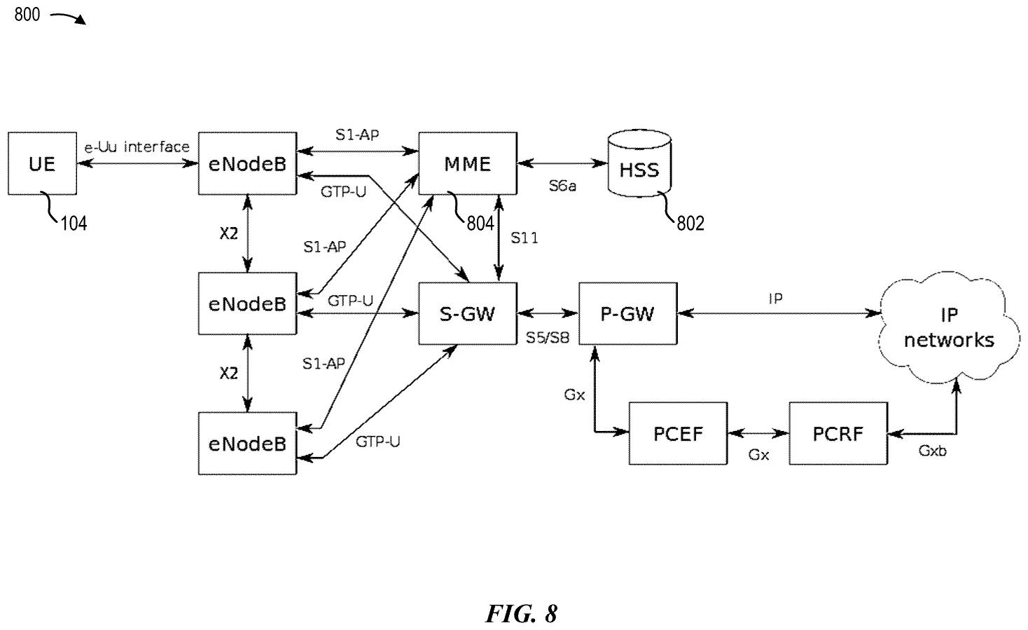

Referring to the diagram 800 of FIG. 8, for an LTE implementation, support of Aerial UE function may be stored in the user's subscription information in HSS 802. HSS 802 transfers this information to the MME during Attach, Service Request and Tracking Area Update procedures.

The subscription information may be provided from the MME to the eNB via the S1-AP Initial Context Setup Request during Attach, Tracking Area Update and Service Request procedures. The subscription information may also be updated via the S1-AP UE Context Modification Request message. In addition, for X2-based handover, the source eNodeB may include the subscription information in the X2-AP Handover Request message to the target eNodeB. For the intra and inter MME S1 based handover, the MME provides the subscription information to the target eNB after the handover procedure.

In some cases, an eNB supporting Aerial UE function handling uses the per user information supplied by the MME to determine whether or not to allow the UE to use Aerial UE function. Support of Aerial UE function is stored in the user's subscription information in HSS 802. HSS 802 transfers this information to the MME via Update Location message during Attach and Tracking Area Update procedures. A Home Operator may revoke user's subscription authorization for operating Aerial UEs at any time.

An MME 804 that supports Aerial UE function provides the user's subscription information on Aerial UE authorization to the eNB via the S1 AP Initial Context Setup Request during Attach, Tracking Area Update and Service Request procedures. For the intra and inter MME S1 based handover (intra RAT) or Inter-RAT handover to E-UTRAN, the Aerial UE subscription information for the user is included in the S1-AP UE Context Modification Request message sent to the target eNodeB after the handover procedure.

### Example Techniques for Managing Aerial Device Violations

There may be various zones (e.g., also referred to herein as “special areas”) where the operation of an aerial device (e.g., drone, unmanned aerial vehicle (UAV), or a user equipment (UE)) may be restricted. For example, in a no-transmit zone (NTZ), radio frequency (RF) transmission from the aerial device may not be allowed (e.g., although there may be no restriction on flying and receiving downlink (DL) signals in an NTZ). In a no-fly zone (NFZ), an aerial device may not be allowed to enter or fly within the zone, and thus, no transmission or reception is to occur in a NFZ. Some zones may be considered no-leave zones (NLZ) that provide a geographical fence (Geo-fence). An aerial device may not be allowed to leave this fence (zone). Both transmission and reception may be allowed in an NLZ, but not outside the NLZ.

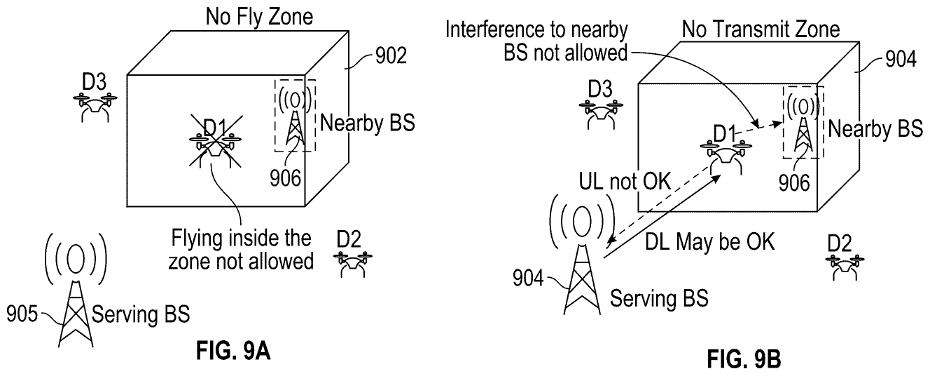

FIG. 9A illustrates an example NFZ 902. As shown, drones labeled “D1,” “D2,”, and “D3” are flying and drone D1 may be within the NFZ and in violation of the NFZ restriction. The drone D1 may be served by a serving base station (BS) 905 outside of the NFZ; another BS 906 (e.g., a BS nearby drone D1) may be within the NFZ. In a similar manner, an NLZ may be provided where a drone D1 should not leave.

FIG. 9B illustrates an example NTZ 904. As shown, drone D1 may be within the NTZ and any uplink (UL) transmission by the drone D1 may result in a violation as such UL transmission may cause interference with the nearby BS 906. Although UL transmission may not be allowed, reception of a DL signal may be allowed, as shown.

Certain aspects of the present disclosure are directed towards techniques for detecting a violation of special area restrictions (e.g., violation of NTZ, NFZ, or NLZ restriction). The detection of the violation may be based on the aerial device location, a planned flightpath of the aerial device, an UL path-loss of the aerial device, or detection from one or more other trusted aerial devices. In some aspects, a separate geographical fencing network (e.g., also referred to as a “stealth network”) may be implanted to detect aerial devices and identify a potential violation. Some aspects also provide techniques for implementing enforcement actions after the detection of a violation.

Some implementations support aerial device reporting of waypoints for a planned flight path, along with timestamps indicating an estimated time of arrival (ETA) at such waypoints using radio resource control (RRC) signaling. If a flight path has been pre-approved by the UTM or the UAS, it may be assumed that the path does not go through an NFZ. However, it may be possible that the aerial device does not follow the planned/approved flight path and still violates special area restrictions. In addition, new restrictions may be in place after the flight path was last approved (e.g., due to a new scenario such as a wildfire or weather event). Therefore, even though the aerial device may follow the flight path, a violation of a special area restriction may occur.

Detection of the location of an aerial device may involve the aerial device (e.g., UE) being configured to provide the location of the aerial device in a measurement report. The measurement report may be periodic. For example, a single location report may be sent or the device may report the last N locations (e.g., N being a positive integer) or the last X time period (e.g., detected locations within the last X time period).

Assuming a radio access network (RAN) entity has information about the restricted area (e.g., a special area such as NFZ, NTZ, or NLZ), the RAN entity may detect that the UE has violated the special area restrictions by comparing the device location against the special area information available to the RAN entity. The information about the restricted area may be provided to the RAN entity by operations, administration, and management (OAM) with the OAM in turn receiving the information from an external service.

In some cases, a mobile network operator (MNO) may report the location of the aerial device to UTM or UAS or a third party providing such verification service. The UTM may take enforcement action if the aerial device's location deviates from the planned path and/or violates any special area restrictions. The reporting by the MNO to UTM/UAS/third party node may be periodic or based on the detection of violation of the planned path by a threshold distance. A network exposure function (NEF) service exposure for monitoring a device location with respect to an area of interest may be supported by providing geo-fencing via MNO location services and verifying the information the aerial device may have already provided directly to UTM.

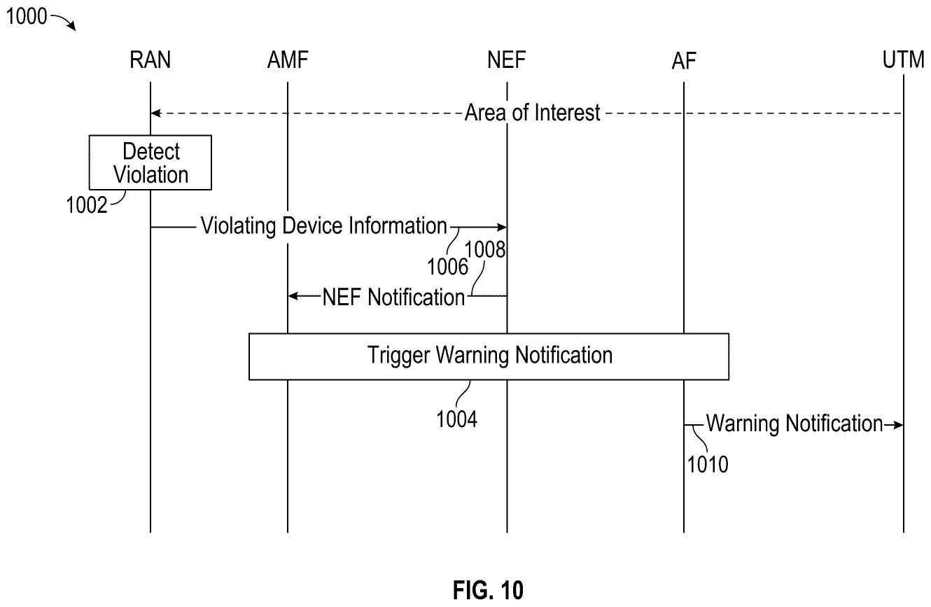

FIG. 10 is a timing diagram 1000 illustrating example operations for managing aerial device special area restriction violations, in accordance with certain aspects of the present disclosure. As shown, at block 1002, a RAN may detect a violation with respect to an NTZ, NFZ, or NLZ. The RAN may trigger an NEF notification to the access management function (AMF) by providing information about the aerial device that is detected as violating the special area restriction. For example, as shown, the RAN may send information 1006 such as aerial device information (e.g., information about the violating aerial device) and area restriction (e.g., NTZ) information (e.g., area restriction being violated) to the NEF, triggering the NEF notification 1008 to the AMF. For instance, the AMF may use an NEF interface (Nnet) notification service, which triggers a network application function (Naf) notification service to trigger a warning notification to the UTM without the UTM having solicited monitoring with respect to an area of interest. In another example, the UTM may a priori register with the NEF of a network to subscribe to notifications of aerial devices violating a special area restriction and may provide a specific area restriction (e.g., NTZ) to be notified about. For example, at block 1004, the AMF may trigger a warning notification 1010 from the application function (AF) to the UTM. The notification by the RAN to the AMF may be based on the detection of a violation of a planned path by a threshold distance. In some cases, the notification by the RAN to the AMF may be periodic. For example, the RAN to AMF notification may be sent periodically regardless of any detection of flight path violation (e.g., and regardless of UTM having to solicit the monitoring). In this case, if no violation is detected, the RAN may send an empty violation list or indicate that no violation is detected.

In some aspects, the monitoring of area of interest may be enhanced to be aerial device agnostic (e.g., as opposed to other implementations that involve the UTM subscribing for a specific aerial device to be monitored). Thus, the UTM may only provide the area of interest to the RAN and may be notified of any aerial device that is potentially violating the area of interest, as shown in timing diagram 1000.

In some aspects, the violation detection may be based on UL path loss for the aerial device. For example, based on UL channel quality estimation, the RAN may detect whether the aerial device may be violating a maximum power (e.g., Ns-Pmax) limit. The UL channel quality estimation may be performed using the device's sounding reference signal (SRS) transmissions. That is, channel quality may be estimated using the SRS transmissions from the aerial device and used to detect whether the aerial device is violating the maximum power limit.

In some aspects, the violation detection may be based on the flight path of the aerial device. For example, the RAN may detect that the aerial device has deviated from an approved flight path by a threshold distance. For instance, the RAN may receive aerial device location reports, based on which the RAN may identify whether the aerial device has strayed from an approved flight path by a threshold distance. The threshold distance may be configurable and may be different for different aerial devices (or different based on the area restriction being monitored). In some cases, the RAN may identify whether the aerial device has strayed from the flight path based on the current serving cell of the aerial device. For instance, if a serving cell of the aerial device is known not to service an area within the threshold distance of the flight path, the aerial device may be determined to have strayed from that flight path. Upon detecting the violation, the RAN may take enforcement actions as described in more detail herein.

The flightpath may be provided to the MNO and the RAN and may be associated with a threshold configurable by a UTM service (e.g., may not be the same for all aerial devices) depending on the aerial device mission or associated with a united access control (UAC) category (e.g., where aerial device categories may be defined where a category associated with the aerial device is communicated by the aerial device). In this case, the RAN may not have complete information regarding the special area restrictions yet still identify violation based on deviation from the flight path of the aerial device.

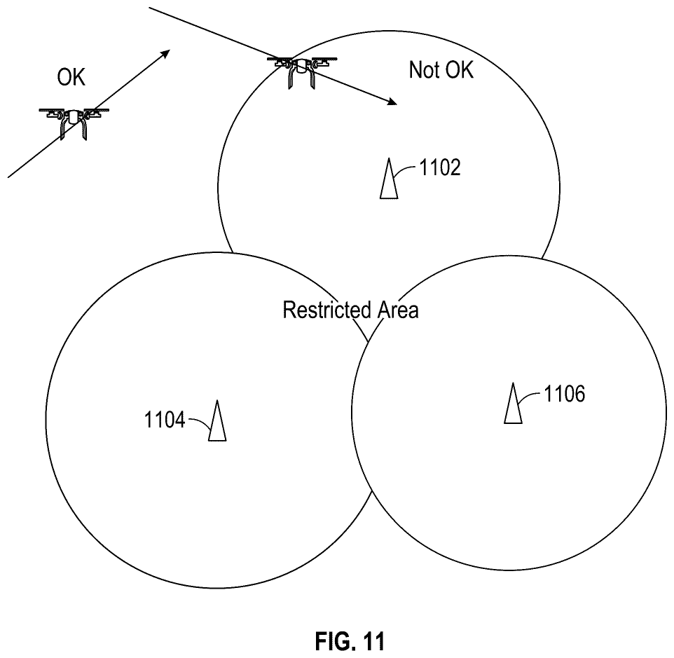

In some aspects, violation detection may be performed using coordinated or trusted aerial devices (e.g., UAVs). That is, trusted aerial devices supporting 3GPP technology may be deployed by concerned authorities to monitor other aerial devices (e.g., UAVs) using the 3GPP cellular technology. Aerial device-based monitoring may provide more accurate information (e.g., coordinates, height, and other capabilities) of the nearby aerial devices that are detected and enable more vigilance. The aerial device may feedback the information to the cellular operator or the UTM (e.g., depending on the entity in charge of enforcement). Some aspects are directed toward using a special network for geo-fencing enforcement, as described in more detail with respect to FIG. 11.

FIG. 11 illustrates stealth networks used to detect aerial device violations, in accordance with certain aspects of the present disclosure. Dedicated cellular base stations (e.g., base stations 1102, 1104, 1106) may be deployed by concerned authorities for geo-fencing and detection purposes. The dedicated base stations may not be intended for serving aerial devices, but may rather be used to implement a stealth network intended for detection of rogue aerial devices. The dedicated base stations may be deployed by the airport agency around the airport or by the military around military infrastructure. The aerial device may not be connected to this stealth network and/or may not be aware of the existence of such a network. The detection of a potentially rogue aerial device by such a network may be independent of the aerial device's provided location (e.g., the aerial device's reported location may not be blindly trusted). Suppose an aerial device is detected within the vicinity of such cellular base stations, as shown. In that case, the aerial device may be considered to have entered a prohibited zone/special area. The detection may be based on sensing physical layer (PHY) signals transmitted by the aerial device, such as by sensing an SRS as described herein.

In some aspects, the stealth network may coordinate with the serving network of the aerial device to identify the aerial device. For example, the dedicated base station may sense the aerial device's transmission (e.g., SRS transmission) and identify resources used for the transmission. The identified resources may be communicated to one or more serving base stations in the area to be compared with resources configured by devices served by the serving base stations. Based on the comparison, the serving base station of the aerial device may identify the aerial device and communicate an identifier of the aerial device to the dedicated base station.

In some aspects, the stealth network may indicate the violation to the serving network. In some aspects, the stealth network may report (e.g., directly) the violation by the aerial device to the UTM/UAS or local authorities.

Certain aspects are directed toward potential enforcement actions. Suppose a RAN detects the special area violation (e.g., based on flight path, aerial device location, or other techniques). In that case, the violation may be reported to the MNO and the MNO may be able to enforce geo-fencing or configure a specific flight path. However, enforcement actions may differ based on whether the violation is for NTZ, NFZ, or NLZ. For instance, for NFZ, lost connectivity may not constitute enforcement because, even without connectivity, the aerial is still flying within the NFZ. In fact, lost connectivity may create other problems. For instance, having the aerial device transition to radio resource control (RRC) idle (RRC_IDLE) or disconnecting the aerial device from the network may result in no further command and control (C2) messages via the cellular connection that could otherwise be used to direct the aerial device outsize the NFZ.

On the other hand, for NTZ or NLZ, it would be beneficial to terminate the UL connectivity (or take action to prevent UL signaling) of the aerial device while flying within the NTZ or outside the NLZ. The aerial device may still be connected to the network and receive DL commands (e.g., C2 messages) and signals. However, the aerial device may be unable to respond (e.g., no UL may be performed while there may be DL-only cells in the NTZ area). For instance, the serving base station may not allocate any UL resources to the aerial device in violation, but still allocate resources for DL.

In some aspects, the aerial device may be moved to RRC_IDLE mode or inactive mode and continue flight according to an original plan. For example, the aerial device may continue flying using autonomous collision avoidance and flight tracking capabilities using PC5-based broadcasting UAV identification (BRID) or detect and avoid (DAA) protocols based on a predefined flight path until the aerial device exits the NTZ (or reenters the NLZ) and starts communicating with the network again. In other words, the aerial device may experience a temporary loss of cellular coverage.

Location sharing for special area enforcement may involve receiving user consent. Many aerial devices are expected to continuously provide location information to the UTM for network remote identification (ID). Consent for providing a flight path may be implicit in the indication of the availability of a flight path. In some cases, consent for sharing location could be implicit based on the UAV subscription.

### Example Operations

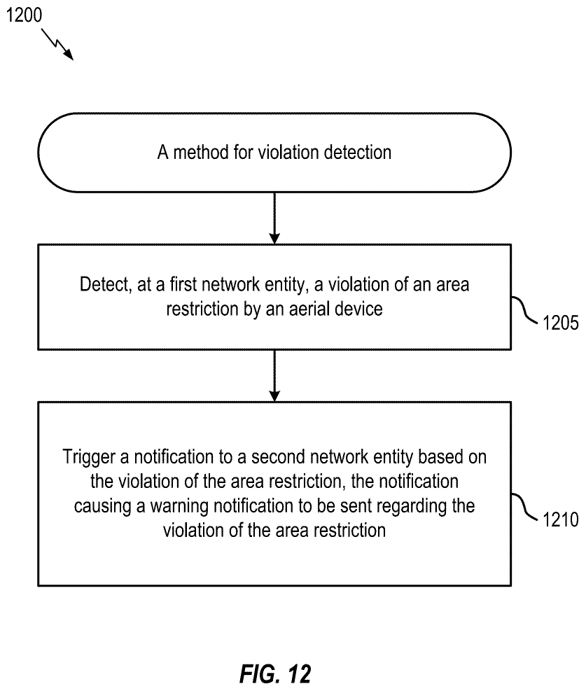

FIG. 12 shows an example of a method 1200 of wireless communication at a network entity (e.g., a radio access network (RAN) entity). As used herein, a RAN entity may be any network entity of a RAN, such as a BS 102 of FIGS. 1 and 3, or a disaggregated base station as discussed with respect to FIG. 2.

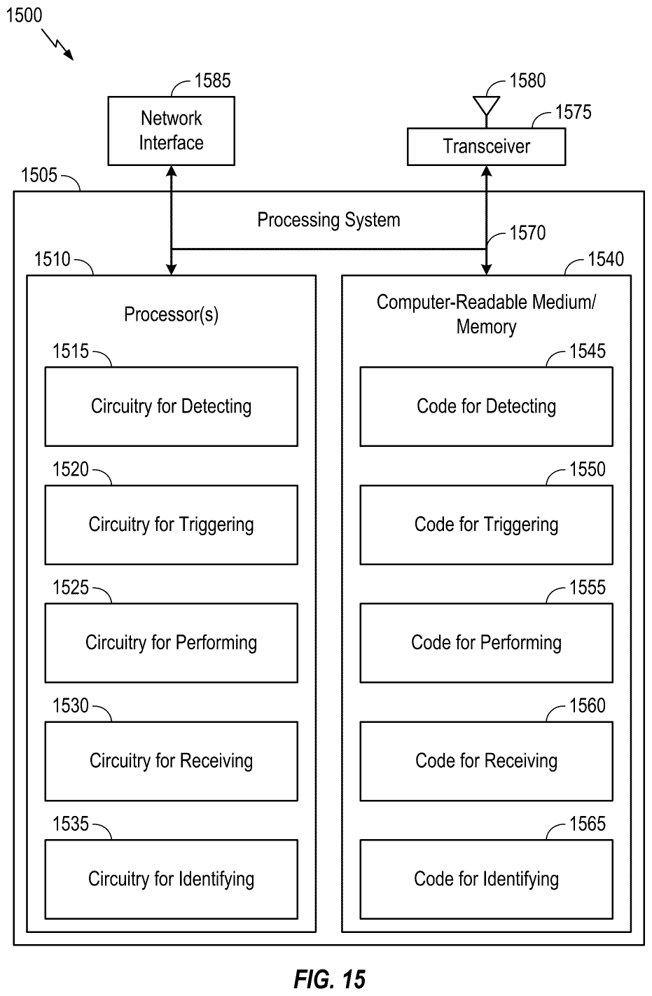

Method 1200 begins at step 1205 with detecting, at a first network entity (e.g., RAN entity), a violation of an area restriction by an aerial device. In some cases, the operations of this step refer to, or may be performed by, circuitry for detecting and/or code for detecting as described with reference to FIG. 15.

Method 1200 then proceeds to step 1210 with triggering a notification (e.g., network exposure function (NEF) notification) to a second network entity (e.g., AMF entity) based on the violation of the area restriction, the notification causing a warning notification to be sent regarding the violation of the area restriction. In some cases, the operations of this step refer to, or may be performed by, circuitry for triggering and/or code for triggering as described with reference to FIG. 15.

In some aspects, the method 1200 further includes performing aerial device monitoring without a solicitation for monitoring by a third party controller, wherein the violation is detected based on the aerial device monitoring. In some cases, the operations of this step refer to, or may be performed by, circuitry for performing and/or code for performing as described with reference to FIG. 15.

In some aspects, the aerial device monitoring is aerial device identifier agnostic.

In some aspects, triggering the NEF notification comprises providing information about the aerial device violating the area restriction to the NEF.

In some aspects, the method 1200 further includes receiving, at the second network entity, the NEF notification. In some cases, the operations of this step refer to, or may be performed by, circuitry for receiving and/or code for receiving as described with reference to FIG. 15.

In some aspects, the method 1200 further includes triggering, at the second network entity, the warning notification via an NEF notification service based on the NEF notification. In some cases, the operations of this step refer to, or may be performed by, circuitry for triggering and/or code for triggering as described with reference to FIG. 15.

In some aspects, the NEF notification service triggers an application function (AF) service to send the warning notification.

In some aspects, the method 1200 further includes receiving, from a third party controller, an indication of an area associated with the area restriction, wherein the detection of the violation is performed based on the indication of the area. In some cases, the operations of this step refer to, or may be performed by, circuitry for receiving and/or code for receiving as described with reference to FIG. 15.

In some aspects, the method 1200 further includes performing aerial device monitoring within an area associated with the area restriction, wherein violation by the aerial device is detected based on the aerial device monitoring. In some cases, the operations of this step refer to, or may be performed by, circuitry for performing and/or code for performing as described with reference to FIG. 15.

In some aspects, detecting the violation comprises detecting that the aerial device has deviated from a flight path by a threshold distance.

In some aspects, the violation is detected based on detection of physical layer (PHY) signals by the aerial device.

In some aspects, the PHY signals comprises a sounding reference signal (SRS).

In some aspects, detecting the violation comprises performing uplink (UL) channel quality estimation based on one or more signal transmissions from the aerial device.

In some aspects, the first network entity is a base station dedicated to aerial device monitoring for violation detection.

In some aspects, the base station is different than a serving base station of the aerial device.

In some aspects, the method 1200 further includes identifying the aerial device using coordination with a serving network of the aerial device. In some cases, the operations of this step refer to, or may be performed by, circuitry for identifying and/or code for identifying as described with reference to FIG. 15.

In some aspects, detecting the violation comprises: identifying one or more resources used for one or more signal transmissions by the aerial device; indicating the one or more resources to a serving network of the aerial device; and receiving an identification of the aerial device based on the one or more resources.

In some aspects, the detection of the violation is independent of any location information provided by the aerial device.

In one aspect, method 1200, or any aspect related to it, may be performed by an apparatus, such as communications device 1500 of FIG. 15, which includes various components operable, configured, or adapted to perform the method 1200. Communications device 1500 is described below in further detail.

Note that FIG. 12 is just one example of a method, and other methods including fewer, additional, or alternative steps are possible consistent with this disclosure.

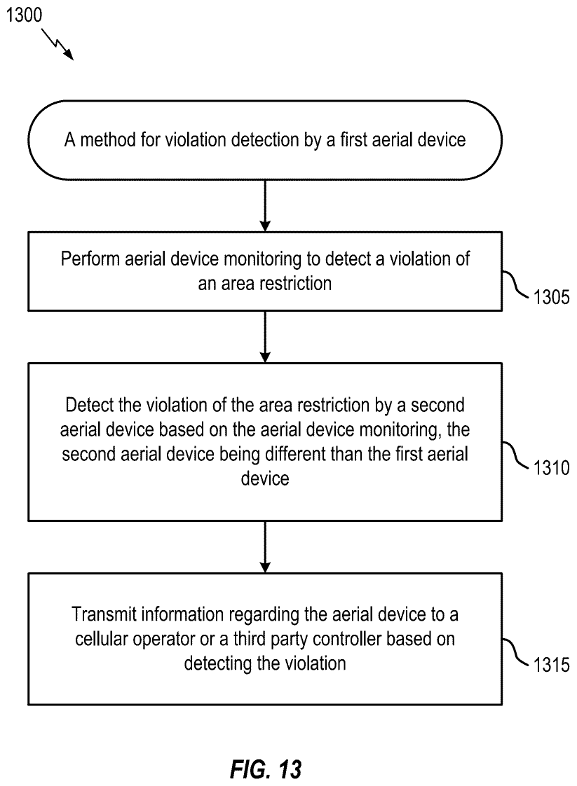

FIG. 13 shows an example of a method 1300 of violation detection by a first aerial device, such as a UE 104 of FIGS. 1 and 3.

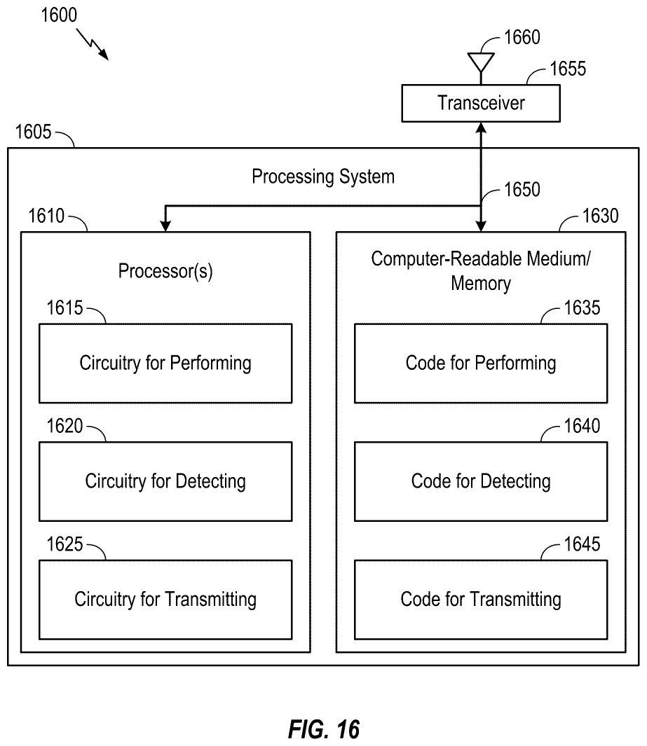

Method 1300 begins at step 1305 with performing aerial device monitoring to detect a violation of an area restriction. In some cases, the operations of this step refer to, or may be performed by, circuitry for performing and/or code for performing as described with reference to FIG. 16.

Method 1300 then proceeds to step 1310 with detecting the violation of the area restriction by a second aerial device based on the aerial device monitoring, the second aerial device being different than the first aerial device. In some cases, the operations of this step refer to, or may be performed by, circuitry for detecting and/or code for detecting as described with reference to FIG. 16.

Method 1300 then proceeds to step 1315 with transmitting information regarding the aerial device to a cellular operator or a third party controller based on detecting the violation. In some cases, the operations of this step refer to, or may be performed by, circuitry for transmitting and/or code for transmitting as described with reference to FIG. 16.

In some aspects, the information comprises at least one of a location of the aerial device, a height of aerial device, or one or more capabilities of the aerial device.

In one aspect, method 1300, or any aspect related to it, may be performed by an apparatus, such as communications device 1600 of FIG. 16, which includes various components operable, configured, or adapted to perform the method 1300. Communications device 1600 is described below in further detail.

Note that FIG. 13 is just one example of a method, and other methods including fewer, additional, or alternative steps are possible consistent with this disclosure.

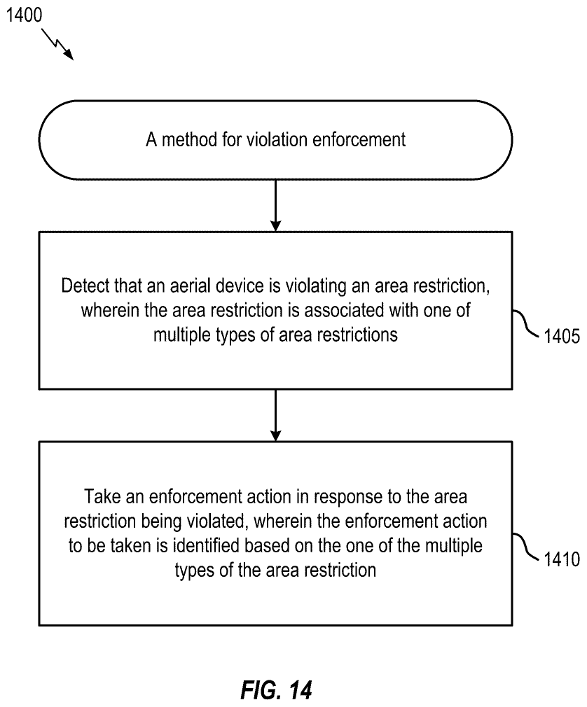

FIG. 14 shows an example of a method 1400 of wireless communication at a controller (e.g., a controller of a cellular operator or UTM) or network entity, such as a BS 102 of FIGS. 1 and 3, or a disaggregated base station as discussed with respect to FIG. 2.

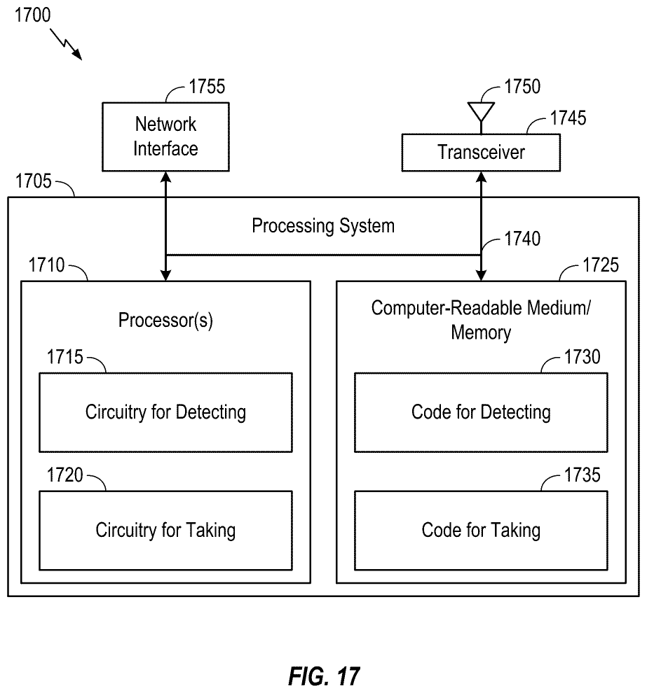

Method 1400 begins at step 1405 with detecting that an aerial device is violating an area restriction, wherein the area restriction is associated with one of multiple types of area restrictions. In some cases, the operations of this step refer to, or may be performed by, circuitry for detecting and/or code for detecting as described with reference to FIG. 17.

Method 1400 then proceeds to step 1410 with taking an enforcement action in response to the area restriction being violated, wherein the enforcement action to be taken is identified based on the one of the multiple types of the area restriction. In some cases, the operations of this step refer to, or may be performed by, circuitry for taking and/or code for taking as described with reference to FIG. 17.

In some aspects, the multiple types of area restrictions comprise a no-fly zone (NFZ) restriction, a no-transmit zone (NTZ) restriction, or a no-leave zone (NLZ) restriction.

In some aspects, taking the enforcement action comprises taking action to prevent downlink (DL) signaling to the aerial device based on the one of the multiple types of area restrictions being an NTZ restriction or an NLZ restriction.

In some aspects, the action to prevent DL signaling to the aerial device is taken while maintaining connectivity to a wireless network for the aerial device.

In some aspects, taking the enforcement action comprises taking action to move the aerial device to idle or inactive mode based on the one of the multiple types of area restrictions being an NTZ restriction or an NLZ restriction.

In one aspect, method 1400, or any aspect related to it, may be performed by an apparatus, such as communications device 1700 of FIG. 17, which includes various components operable, configured, or adapted to perform the method 1400. Communications device 1700 is described below in further detail.

Note that FIG. 14 is just one example of a method, and other methods including fewer, additional, or alternative steps are possible consistent with this disclosure.

### Example Communications Device(s)

FIG. 15 depicts aspects of an example communications device 1500. In some aspects, communications device 1500 is a network entity, such as BS 102 of FIGS. 1 and 3, or a disaggregated base station as discussed with respect to FIG. 2.

The communications device 1500 includes a processing system 1505 coupled to the transceiver 1575 (e.g., a transmitter and/or a receiver) and/or a network interface 1585. The transceiver 1575 is configured to transmit and receive signals for the communications device 1500 via the antenna 1580, such as the various signals as described herein. The network interface 1585 is configured to obtain and send signals for the communications device 1500 via communication link(s), such as a backhaul link, midhaul link, and/or fronthaul link as described herein, such as with respect to FIG. 2. The processing system 1505 may be configured to perform processing functions for the communications device 1500, including processing signals received and/or to be transmitted by the communications device 1500.

The processing system 1505 includes one or more processors 1510. In various aspects, one or more processors 1510 may be representative of one or more of receive processor 338, transmit processor 320, TX MIMO processor 330, and/or controller/processor 340, as described with respect to FIG. 3. The one or more processors 1510 are coupled to a computer-readable medium/memory 1540 via a bus 1570. In certain aspects, the computer-readable medium/memory 1540 is configured to store instructions (e.g., computer-executable code) that when executed by the one or more processors 1510, cause the one or more processors 1510 to perform the method 1200 described with respect to FIG. 12, or any aspect related to it. Note that reference to a processor of communications device 1500 performing a function may include one or more processors 1510 of communications device 1500 performing that function.

In the depicted example, the computer-readable medium/memory 1540 stores code (e.g., executable instructions), such as code for detecting 1545, code for triggering 1550, code for performing 1555, code for receiving 1560, and code for identifying 1565. Processing of the code for detecting 1545, code for triggering 1550, code for performing 1555, code for receiving 1560, and code for identifying 1565 may cause the communications device 1500 to perform the method 1200 described with respect to FIG. 12, or any aspect related to it.

The one or more processors 1510 include circuitry configured to implement (e.g., execute) the code stored in the computer-readable medium/memory 1540, including circuitry such as circuitry for detecting 1515, circuitry for triggering 1520, circuitry for performing 1525, circuitry for receiving 1530, and circuitry for identifying 1535. Processing with circuitry for detecting 1515, circuitry for triggering 1520, circuitry for performing 1525, circuitry for receiving 1530, and circuitry for identifying 1535 may cause the communications device 1500 to perform the method 1200 described with respect to FIG. 12, or any aspect related to it.

Various components of the communications device 1500 may provide means for performing the method 1200 described with respect to FIG. 12, or any aspect related to it. Means for transmitting, sending or outputting for transmission may include transceivers 332 and/or antenna(s) 334 of the BS 102 illustrated in FIG. 3 and/or the transceiver 1575 and the antenna 1580 of the communications device 1500 in FIG. 15. Means for receiving or obtaining may include transceivers 332 and/or antenna(s) 334 of the BS 102 illustrated in FIG. 3 and/or the transceiver 1575 and the antenna 1580 of the communications device 1500 in FIG. 15.

FIG. 16 depicts aspects of an example communications device 1600. In some aspects, communications device 1600 is a user equipment, such as UE 104 described above with respect to FIGS. 1 and 3.

The communications device 1600 includes a processing system 1605 coupled to the transceiver 1655 (e.g., a transmitter and/or a receiver). The transceiver 1655 is configured to transmit and receive signals for the communications device 1600 via the antenna 1660, such as the various signals as described herein. The processing system 1605 may be configured to perform processing functions for the communications device 1600, including processing signals received and/or to be transmitted by the communications device 1600.

The processing system 1605 includes one or more processors 1610. In various aspects, the one or more processors 1610 may be representative of one or more of receive processor 358, transmit processor 364, TX MIMO processor 366, and/or controller/processor 380, as described with respect to FIG. 3. The one or more processors 1610 are coupled to a computer-readable medium/memory 1630 via a bus 1650. In certain aspects, the computer-readable medium/memory 1630 is configured to store instructions (e.g., computer-executable code) that when executed by the one or more processors 1610, cause the one or more processors 1610 to perform the method 1300 described with respect to FIG. 13, or any aspect related to it. Note that reference to a processor performing a function of communications device 1600 may include one or more processors 1610 performing that function of communications device 1600.

In the depicted example, computer-readable medium/memory 1630 stores code (e.g., executable instructions), such as code for performing 1635, code for detecting 1640, and code for transmitting 1645. Processing of the code for performing 1635, code for detecting 1640, and code for transmitting 1645 may cause the communications device 1600 to perform the method 1300 described with respect to FIG. 13, or any aspect related to it.

The one or more processors 1610 include circuitry configured to implement (e.g., execute) the code stored in the computer-readable medium/memory 1630, including circuitry such as circuitry for performing 1615, circuitry for detecting 1620, and circuitry for transmitting 1625. Processing with circuitry for performing 1615, circuitry for detecting 1620, and circuitry for transmitting 1625 may cause the communications device 1600 to perform the method 1300 described with respect to FIG. 13, or any aspect related to it.

Various components of the communications device 1600 may provide means for performing the method 1300 described with respect to FIG. 13, or any aspect related to it. For example, means for transmitting, sending or outputting for transmission may include transceivers 354 and/or antenna(s) 352 of the UE 104 illustrated in FIG. 3 and/or the transceiver 1655 and the antenna 1660 of the communications device 1600 in FIG. 16. Means for receiving or obtaining may include transceivers 354 and/or antenna(s) 352 of the UE 104 illustrated in FIG. 3 and/or the transceiver 1655 and the antenna 1660 of the communications device 1600 in FIG. 16.

FIG. 17 depicts aspects of an example communications device 1700. In some aspects, communications device 1700 is controller device (e.g., controller of a cellular operator or UTM) or a network entity, such as BS 102 of FIGS. 1 and 3, or a disaggregated base station as discussed with respect to FIG. 2.

The communications device 1700 includes a processing system 1705 coupled to the transceiver 1745 (e.g., a transmitter and/or a receiver) and/or a network interface 1755. The transceiver 1745 is configured to transmit and receive signals for the communications device 1700 via the antenna 1750, such as the various signals as described herein. The network interface 1755 is configured to obtain and send signals for the communications device 1700 via communication link(s), such as a backhaul link, midhaul link, and/or fronthaul link as described herein, such as with respect to FIG. 2. The processing system 1705 may be configured to perform processing functions for the communications device 1700, including processing signals received and/or to be transmitted by the communications device 1700.

The processing system 1705 includes one or more processors 1710. In various aspects, one or more processors 1710 may be representative of one or more of receive processor 338, transmit processor 320, TX MIMO processor 330, and/or controller/processor 340, as described with respect to FIG. 3. The one or more processors 1710 are coupled to a computer-readable medium/memory 1725 via a bus 1740. In certain aspects, the computer-readable medium/memory 1725 is configured to store instructions (e.g., computer-executable code) that when executed by the one or more processors 1710, cause the one or more processors 1710 to perform the method 1400 described with respect to FIG. 14, or any aspect related to it. Note that reference to a processor of communications device 1700 performing a function may include one or more processors 1710 of communications device 1700 performing that function.

In the depicted example, the computer-readable medium/memory 1725 stores code (e.g., executable instructions), such as code for detecting 1730 and code for taking 1735. Processing of the code for detecting 1730 and code for taking 1735 may cause the communications device 1700 to perform the method 1400 described with respect to FIG. 14, or any aspect related to it.

The one or more processors 1710 include circuitry configured to implement (e.g., execute) the code stored in the computer-readable medium/memory 1725, including circuitry such as circuitry for detecting 1715 and circuitry for taking 1720. Processing with circuitry for detecting 1715 and circuitry for taking 1720 may cause the communications device 1700 to perform the method 1400 described with respect to FIG. 14, or any aspect related to it.

Various components of the communications device 1700 may provide means for performing the method 1400 described with respect to FIG. 14, or any aspect related to it. Means for transmitting, sending or outputting for transmission may include transceivers 332 and/or antenna(s) 334 of the BS 102 illustrated in FIG. 3 and/or the transceiver 1745 and the antenna 1750 of the communications device 1700 in FIG. 17. Means for receiving or obtaining may include transceivers 332 and/or antenna(s) 334 of the BS 102 illustrated in FIG. 3 and/or the transceiver 1745 and the antenna 1750 of the communications device 1700 in FIG. 17.

### Example Clauses

Implementation examples are described in the following numbered clauses:

Clause 1: A method for violation detection, comprising: detecting, at a first network entity, a violation of an area restriction by an aerial device; and triggering a network exposure function (NEF) notification to a second network entity based on the violation of the area restriction, the NEF notification causing a warning notification to be sent regarding the violation of the area restriction.

Clause 2: The method of Clause 1, wherein the first network entity comprises a radio access network entity (RAN) entity, and wherein the second network entity comprises an access management function (AMF) entity.

Clause 3: The method of Clause 1 or 2, further comprising performing aerial device monitoring without a solicitation for monitoring by a third party controller, wherein the violation is detected based on the aerial device monitoring.

Clause 4: The method of Clause 3, wherein the aerial device monitoring is aerial device identifier agnostic.

Clause 5: The method according to any of Clauses 1-4, wherein triggering the NEF notification comprises providing information about the aerial device violating the area restriction to the NEF.

Clause 6: The method according to any of Clauses 1-5, further comprising: receiving, at the second network entity, the NEF notification; and triggering, at the second network entity, the warning notification via an NEF notification service based on the NEF notification.

Clause 7: The method of Clause 6, wherein the NEF notification service triggers an application function (AF) service to send the warning notification.

Clause 8: The method according to any of Clauses 1-7, further comprising receiving, from a third party controller, an indication of an area associated with the area restriction, wherein the detection of the violation is performed based on the indication of the area.

Clause 9: The method according to any of Clauses 1-8, further comprising performing aerial device monitoring within an area associated with the area restriction, wherein violation by the aerial device is detected based on the aerial device monitoring.

Clause 10: The method according to any of Clauses 1-9, wherein detecting the violation comprises detecting that the aerial device has deviated from a flight path by a threshold distance.

Clause 11: The method according to any of Clauses 1-10, wherein the violation is detected based on detection of physical layer (PHY) signals by the aerial device.

Clause 12: The method of Clause 11, wherein the PHY signals comprises a sounding reference signal (SRS).

Clause 13: The method according to any of Clauses 1-12, wherein detecting the violation comprises performing uplink (UL) channel quality estimation based on one or more signal transmissions from the aerial device.

Clause 14: The method according to any of Clauses 1-13, wherein the first network entity is a base station dedicated to aerial device monitoring for violation detection.

Clause 15: The method of Clause 14, wherein the base station is different than a serving base station of the aerial device.

Clause 16: The method according to any of Clauses 1-15, further comprising identifying the aerial device using coordination with a serving network of the aerial device.

Clause 17: The method according to any of Clauses 1-16, wherein detecting the violation comprises: identifying one or more resources used for one or more signal transmissions by the aerial device; indicating the one or more resources to a serving network of the aerial device; and receiving an identification of the aerial device based on the one or more resources.

Clause 18: The method according to any of Clauses 1-17, wherein the detection of the violation is independent of any location information provided by the aerial device.

Clause 19: A method for violation detection by a first aerial device, comprising: performing aerial device monitoring to detect a violation of an area restriction; detecting the violation of the area restriction by a second aerial device based on the aerial device monitoring, the second aerial device being different than the first aerial device; and transmitting information regarding the aerial device to a cellular operator or a third party controller based on detecting the violation.

Clause 20: The method of Clause 19, wherein the information comprises at least one of a location of the aerial device, a height of aerial device, or one or more capabilities of the aerial device.

Clause 21: A method for violation enforcement, comprising: detecting that an aerial device is violating an area restriction, wherein the area restriction is associated with one of multiple types of area restrictions; and taking an enforcement action in response to the area restriction being violated, wherein the enforcement action to be taken is identified based on the one of the multiple types of the area restriction.

Clause 22: The method of Clause 21, wherein the multiple types of area restrictions comprise a no-fly zone (NFZ) restriction, a no-transmit zone (NTZ) restriction, or a no-leave zone (NLZ) restriction.

Clause 23: The method of Clause 21 or 22, wherein taking the enforcement action comprises taking action to prevent downlink (DL) signaling to the aerial device based on the one of the multiple types of area restrictions being an NTZ restriction or an NLZ restriction.

Clause 24: The method of Clause 23, wherein the action to prevent DL signaling to the aerial device is taken while maintaining connectivity to a wireless network for the aerial device.

Clause 25: The method according to any of Clauses 21-24, wherein taking the enforcement action comprises taking action to move the aerial device to idle or inactive mode based on the one of the multiple types of area restrictions being an NTZ restriction or an NLZ restriction.

Clause 26: An apparatus, comprising: at least one memory comprising executable instructions; and at least one processor configured to execute the executable instructions and cause the apparatus to perform a method in accordance with any combination of Clauses 1-25.

Clause 27: An apparatus, comprising means for performing a method in accordance with any combination of Clauses 1-25.

Clause 28: A non-transitory computer-readable medium comprising executable instructions that, when executed by at least one processor of an apparatus, cause the apparatus to perform a method in accordance with any combination of Clauses 1-25.

Clause 29: A computer program product embodied on a computer-readable storage medium comprising code for performing a method in accordance with any combination of Clauses 1-25.

Clause 30: An apparatus for violation detection, comprising: memory; and one or more processors coupled to the memory and configured to: detect, at a first network entity, a violation of an area restriction by an aerial device; and trigger a notification to a second network entity based on the violation of the area restriction, the notification causing a warning notification to be sent regarding the violation of the area restriction.

Clause 31: The apparatus of Clause 30, wherein: the notification comprises a network exposure function (NEF) notification; and to trigger the notification, the one or more processors are configured to provide information about the aerial device violating the area restriction to a network exposure function (NEF).

Clause 32: The apparatus of Clause 30 or 31, wherein the first network entity

comprises a radio access network entity (RAN) entity, and wherein the second network entity comprises an access management function (AMF) entity.

Clause 33: The apparatus according to any of Clauses 30-32, wherein the one or more processors are further configured to perform aerial device monitoring without a solicitation for monitoring by a third party controller, wherein the violation is detected based on the aerial device monitoring.

Clause 34: The apparatus of Clause 4, wherein the aerial device monitoring is agnostic of an identifier of the aerial device.

Clause 35: The apparatus according to any of Clauses 30-34, wherein the one or more processors are further configured to: receive, at the second network entity, the notification; and trigger, at the second network entity, the warning notification via an NEF notification service based on the notification.

Clause 36: The apparatus of Clause 6, wherein the NEF notification service triggers an application function (AF) service to send the warning notification.

Clause 37: The apparatus according to any of Clauses 30-36, wherein the one or more processors are further configured to receive, from a third party controller, an indication of an area associated with the area restriction, wherein the detection of the violation is performed based on the indication of the area.

Clause 38: The apparatus according to any of Clauses 30-37, wherein the one or more processors are further configured to perform aerial device monitoring within an area associated with the area restriction, wherein the violation by the aerial device is detected based on the aerial device monitoring.

Clause 39: The apparatus according to any of Clauses 30-38, wherein, to detect the violation, the one or more processors are configured to detect detecting that the aerial device has deviated from a flight path by a threshold distance.

Clause 40: The apparatus according to any of Clauses 30-39, wherein the one or more processors are configured to detect the violation based on detection of physical layer (PHY) signals by the aerial device.

Clause 41: The apparatus of Clause 40, wherein the PHY signals comprises a sounding reference signal (SRS).

Clause 42: The apparatus according to any of Clauses 30-41, wherein, to detect the violation, the one or more processors are configured to perform uplink (UL) channel quality estimation based on one or more signal transmissions from the aerial device.

Clause 43: The apparatus according to any of Clauses 30-42, wherein the first network entity is a base station dedicated to aerial device monitoring for violation detection.

Clause 44: The apparatus of Clause 14, wherein the base station is different than a serving base station of the aerial device.

Clause 45: The apparatus according to any of Clauses 30-44, wherein the one or more processors are further configured to identify the aerial device using coordination with a serving network of the aerial device.

Clause 46: The apparatus according to any of Clauses 30-45, wherein, to detect the violation, the one or more processors are configured to: identify one or more resources used for one or more signal transmissions by the aerial device; indicate the one or more resources to a serving network of the aerial device; and receive an identification of the aerial device based on the one or more resources.

Clause 47: The apparatus according to any of Clauses 30-46, wherein the one or more processors are configured to detect the violation independently of any location information provided by the aerial device.

Clause 48: An apparatus for violation detection by a first aerial device, comprising: memory; and one or more processors coupled to the memory and configured to: perform aerial device monitoring to detect a violation of an area restriction; detect the violation of the area restriction by a second aerial device based on the aerial device monitoring, the second aerial device being different than the first aerial device; and transmit information regarding the aerial device to a cellular operator or a third party controller based on detecting the violation.

Clause 49: The apparatus of Clause 48, wherein the information comprises at least one of a location of the aerial device, a height of aerial device, or one or more capabilities of the aerial device.

Clause 50: An apparatus for violation enforcement, comprising: memory; and one or more processors coupled to the memory and configured to: detect that an aerial device is violating an area restriction, wherein the area restriction is associated with one of multiple types of area restrictions; and take an enforcement action in response to the area restriction being violated, wherein the enforcement action to be taken is identified based on the one of the multiple types of the area restriction.

Clause 51: The apparatus of Clause 50, wherein the multiple types of area restrictions comprise a no-fly zone (NFZ) restriction, a no-transmit zone (NTZ) restriction, or a no-leave zone (NLZ) restriction.

Clause 52: The apparatus of Clause 50 or 51, wherein, to take the enforcement action, the one or more processors are configured to take action to prevent downlink (DL) signaling to the aerial device based on the one of the multiple types of area restrictions being an NTZ restriction or an NLZ restriction.

Clause 53: The apparatus of Clause 52, wherein the one or more processors are configured to take the action to prevent DL signaling to the aerial device while maintaining connectivity to a wireless network for the aerial device.

Clause 54: The apparatus according to any of Clauses 50-53, wherein, to take the enforcement action, the one or more processors are configured to take action to move the aerial device to idle or inactive mode based on the one of the multiple types of area restrictions being an NTZ restriction or an NLZ restriction.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for violation detection, comprising:
memory; and
one or more processors coupled to the memory and configured to:
detect, at a first network entity, a violation of an area restriction by an aerial device; and
trigger a notification to a second network entity based on the violation of the area restriction, the notification causing a warning notification to be sent regarding the violation of the area restriction.

2. The apparatus of claim 1, wherein:
the notification comprises a network exposure function (NEF) notification; and
to trigger the notification, the one or more processors are configured to provide information about the aerial device violating the area restriction to a network exposure function (NEF).

3. The apparatus of claim 1, wherein the first network entity comprises a radio access network entity (RAN) entity, and wherein the second network entity comprises an access management function (AMF) entity.

4. The apparatus of claim 1, wherein the one or more processors are further configured to perform aerial device monitoring without a solicitation for monitoring by a third party controller, wherein the violation is detected based on the aerial device monitoring.

5. The apparatus of claim 4, wherein the aerial device monitoring is agnostic of an identifier of the aerial device.

6. The apparatus of claim 1, wherein the one or more processors are further configured to:
receive, at the second network entity, the notification; and
trigger, at the second network entity, the warning notification via an NEF notification service based on the notification.

7. The apparatus of claim 6, wherein the NEF notification service triggers an application function (AF) service to send the warning notification.

8. The apparatus of claim 1, wherein the one or more processors are further configured to receive, from a third party controller, an indication of an area associated with the area restriction, wherein the detection of the violation is performed based on the indication of the area.

9. The apparatus of claim 1, wherein the one or more processors are further configured to perform aerial device monitoring within an area associated with the area restriction, wherein the violation by the aerial device is detected based on the aerial device monitoring.

10. The apparatus of claim 1, wherein, to detect the violation, the one or more processors are configured to detect detecting that the aerial device has deviated from a flight path by a threshold distance.

11. The apparatus of claim 1, wherein the one or more processors are configured to detect the violation based on detection of physical layer (PHY) signals by the aerial device.

12. The apparatus of claim 11, wherein the PHY signals comprises a sounding reference signal (SRS).

13. The apparatus of claim 1, wherein, to detect the violation, the one or more processors are configured to perform uplink (UL) channel quality estimation based on one or more signal transmissions from the aerial device.

14. The apparatus of claim 1, wherein the first network entity is a base station dedicated to aerial device monitoring for violation detection.

15. The apparatus of claim 14, wherein the base station is different than a serving base station of the aerial device.

16. The apparatus of claim 1, wherein the one or more processors are further configured to identify the aerial device using coordination with a serving network of the aerial device.

17. The apparatus of claim 1, wherein, to detect the violation, the one or more processors are configured to:
identify one or more resources used for one or more signal transmissions by the aerial device;
indicate the one or more resources to a serving network of the aerial device; and
receive an identification of the aerial device based on the one or more resources.

18. The apparatus of claim 1, wherein the one or more processors are configured to detect the violation independently of any location information provided by the aerial device.

19. An apparatus for violation detection by a first aerial device, comprising:
memory; and
one or more processors coupled to the memory and configured to:
perform aerial device monitoring to detect a violation of an area restriction;
detect the violation of the area restriction by a second aerial device based on the aerial device monitoring, the second aerial device being different than the first aerial device; and
transmit information regarding the aerial device to a cellular operator or a third party controller based on detecting the violation.

20. The apparatus of claim 19, wherein the information comprises at least one of a location of the aerial device, a height of aerial device, or one or more capabilities of the aerial device.

21. An apparatus for violation enforcement, comprising:
memory; and
one or more processors coupled to the memory and configured to:
detect that an aerial device is violating an area restriction, wherein the area restriction is associated with one of multiple types of area restrictions; and
take an enforcement action in response to the area restriction being violated, wherein the enforcement action to be taken is identified based on the one of the multiple types of the area restriction.

22. The apparatus of claim 21, wherein the multiple types of area restrictions comprise a no-fly zone (NFZ) restriction, a no-transmit zone (NTZ) restriction, or a no-leave zone (NLZ) restriction.

23. The apparatus of claim 21, wherein, to take the enforcement action, the one or more processors are configured to take action to prevent downlink (DL) signaling to the aerial device based on the one of the multiple types of area restrictions being an NTZ restriction or an NLZ restriction.

24. The apparatus of claim 23, wherein the one or more processors are configured to take the action to prevent DL signaling to the aerial device while maintaining connectivity to a wireless network for the aerial device.

25. The apparatus of claim 21, wherein, to take the enforcement action, the one or more processors are configured to take action to move the aerial device to idle or inactive mode based on the one of the multiple types of area restrictions being an NTZ restriction or an NLZ restriction.

26. A method for violation detection, comprising:
detecting, at a first network entity, a violation of an area restriction by an aerial device; and
triggering a notification to a second network entity based on the violation of the area restriction, the notification causing a warning notification to be sent regarding the violation of the area restriction.
